(19) United States
(12) Patent Application Publication
(10) Pub. No.: US 2008/0063507 A1
(43) Pub. Date: Mar. 13, 2008

(54) System for the accumulation and grappling of bales of hay

(76) Inventor: Jerry Miller, Rio Vista, TX (US)

Correspondence Address: HOWREY LLP, C/O IP DOCKETING DEPARTMENT, 2941 FAIRVIEW PARK DRIVE, SUITE 200, FALLS CHURCH, VA, 22042-7195, US

(21) Appl. No.: 11/786,184

(22) Filed: Apr. 11, 2007

Related U.S. Application Data
(60) Provisional application No. 60/790,968, filed on Apr. 11, 2006.

(51) Int. Cl. A01D 90/08; A01D 85/00; A01D 87/04

(52) U.S. Cl. 414/789.7; 414/111; 414/812

(57) ABSTRACT

The present invention provides techniques for accumulation of bales of hay. The disclosed accumulation system allows for the accumulation of at least eight or ten bales of hay into stabled compacted bale pads. The accumulation system employs at least one diverted to direct a bale of hay into at least one shoot. The bale of hay then is pivoted into a biased positioned relative to any additional accumulated bales of hay. The biased position creates a secure abutment for the additional accumulated bales of hay and allows for stabled compacted bale pads. Upon entry into the accumulator of a final hay bale, a release mechanism is triggered thereby opening a rear release gate and depositing a compacted bale bad onto a field ready for moving and pick up by a grapple system.

This application is a Non-provisional application claiming priority to U.S. Provisional Application Ser. No. 60/790,968, entitled “SYSTEM FOR THE ACCUMULATION AND GRAPPLING OF BALES OF HAY” by Jerry B. Miller, filed Apr. 11, 2006, hereby incorporated by reference in it entirety herein.

### FIELD OF INVENTION

### Background of the Invention

The primary technical problems with the prior art is the accumulation of only eight hay bales and the parallel stacking of bales together. Solutions to these problems have not yet been presented in the prior art or in the field. A problem associated with accumulating eight hay bales is the inefficient use of space in the transporting of the accumulated bales. Most bales are transported in the back of vehicles and a pad of eight accumulated hay bales does not use the entire bed of the transportation vehicle. Additionally, the parallel compaction of the bale pad is unstable and can allow for movement of the bales. The apparatus, systems and methods of the present invention resolve both the inefficient use of space in the transportation vehicle and the unstable compaction of the bale pad.

### BRIEF DESCRIPTION OF THE DRAWINGS

The above and other objects and advantages of the present invention will be apparent upon consideration of the following detailed description, taken in conjunction with the accompanying drawings, in which like reference characters refer to like parts throughout, and in which:

FIG. 1 illustrates an exemplary functional diagram of the invention including a funneled entry, two diverter, four bale shoots, a rear gate release trigger and springs to a rear release gate.

FIG. 2a illustrates another exemplary functional block diagram of the rear gate release system of the present invention;

FIG. 2b illustrates a catch element to trigger the opening of a rear release gate;

FIG. 3 illustrates a side view of the present invention with the placement of back release gates and turning brackets;

FIG. 4 illustrates a side view of the present invention.

FIG. 5 illustrates an exemplary functional diagram of the invention including a funneled entry, two diverter, four bale shoots, a rear gate release trigger and springs to a rear release gate.

FIG. 6 illustrates the removal of the turning gate hinge spring and the addition of a spring system change.

FIG. 7 illustrates exemplary attachments for connection of an accumulator system to a baler.

FIG. 8 illustrates exemplary attachments for connection of an accumulator system to a baler.

FIG. 9 illustrates exemplary attachments for connection of an accumulator system to an all terrain vehicle.

FIG. 10 illustrates exemplary attachments for connection of an accumulator system to an automobile.

### DETAILED DESCRIPTION OF THE INVENTION

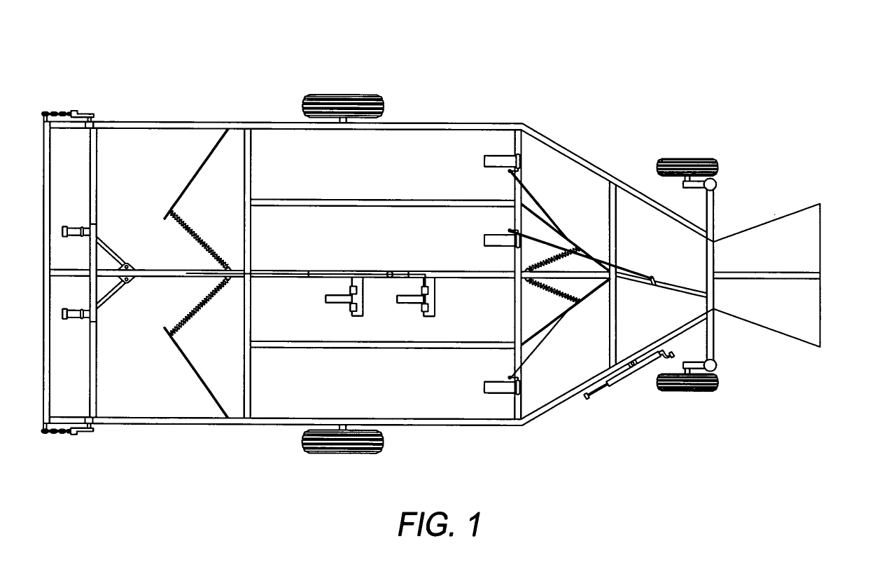

The present invention uses a carriage removably attached to a vehicle, wherein the carriage directs a bale of hay into a perpendicular position relative to at least one addition bale of hay. FIG. 1 shows a functional diagram of an embodiment of the apparatus of the present invention including a wheeled housing with a funneled entry and at least one diverter capable of directing a bale of hay into at least one shoot, a turning gate at the end of the shoot for directing a bale of hay into a perpendicular position relative to additional bales of hay.

In one embodiment of the invention, the accumulator system is attached to a vehicle and maneuvered around a field so as to pick up bales of hay. A bale of hay is positioned at the opening of the accumulator and enters the accumulator via the funneled entry port. The bale is then diverted into an accumulation shoot by a diverting mechanism. The first bale of hay to enter a shoot is directed to the rear portion of the accumulator and slides against a turning gate. The turning gate directs the bale into a perpendicular position relative to any later accumulated bales of hay but it is parallel to the release gate at the rear of the accumulator system. In a preferred embodiment of the present invention, the rear gates of the accumulator are 38.5″ from the back of the accumulator and project into the accumulator at a 45 degree angle. The gates are preferably constructed of 1.5 inch strap steel, are formed in a hook or in such a shape as to be activated by an attached pedal. The hook fastens around a ¾ rod. The gate is hinged at the side of the accumulator.

The turning gates are activated by a hay bale depressing a release pedal at the end of the gate. The gate releases rearward guiding the bale to a perpendicular position against the back of the accumulator. Once the hay bales are in place, the gate is no longer active and folds away into the side of the accumulator. Upon release of the pack of bales, the turning gates being spring loaded return to an original position

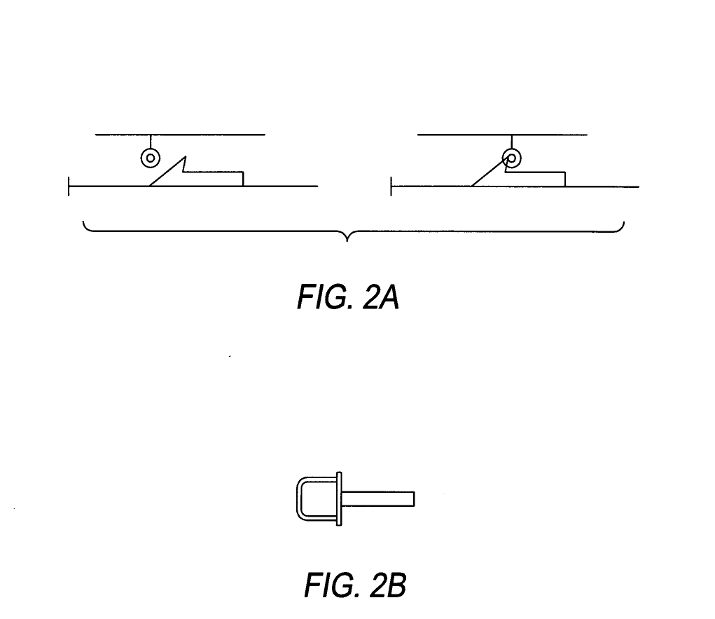

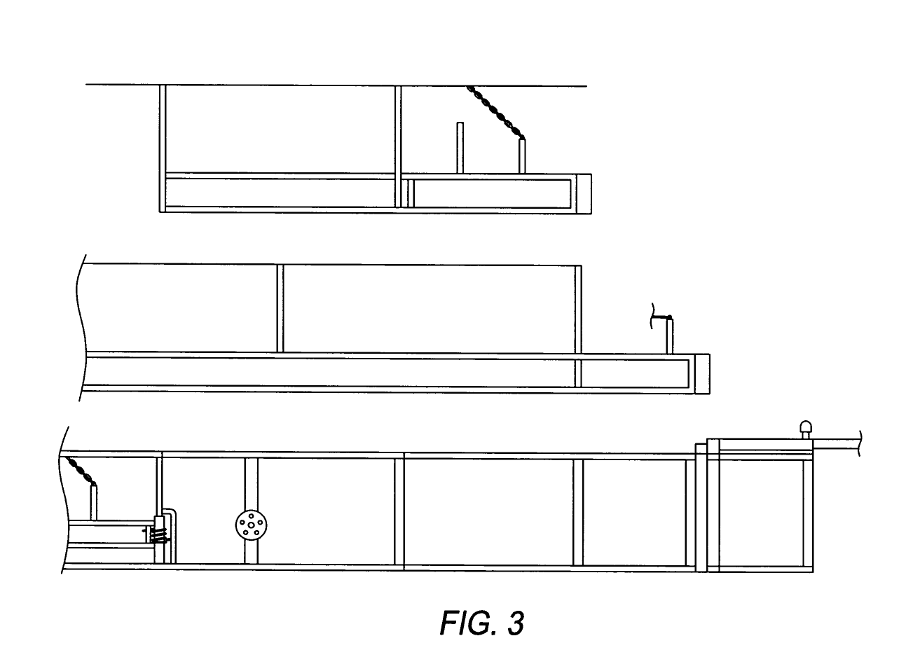

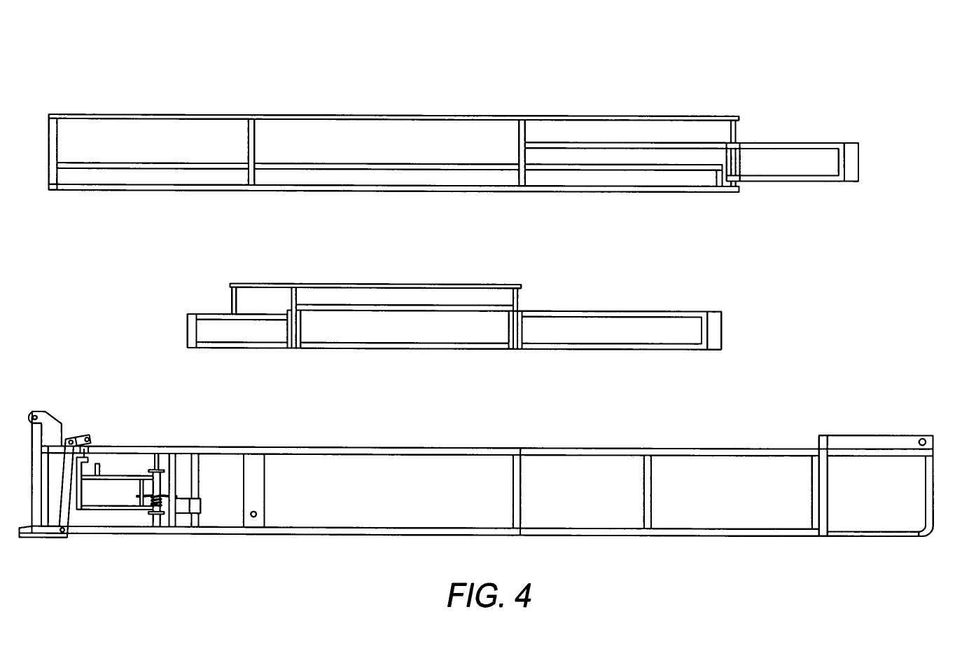

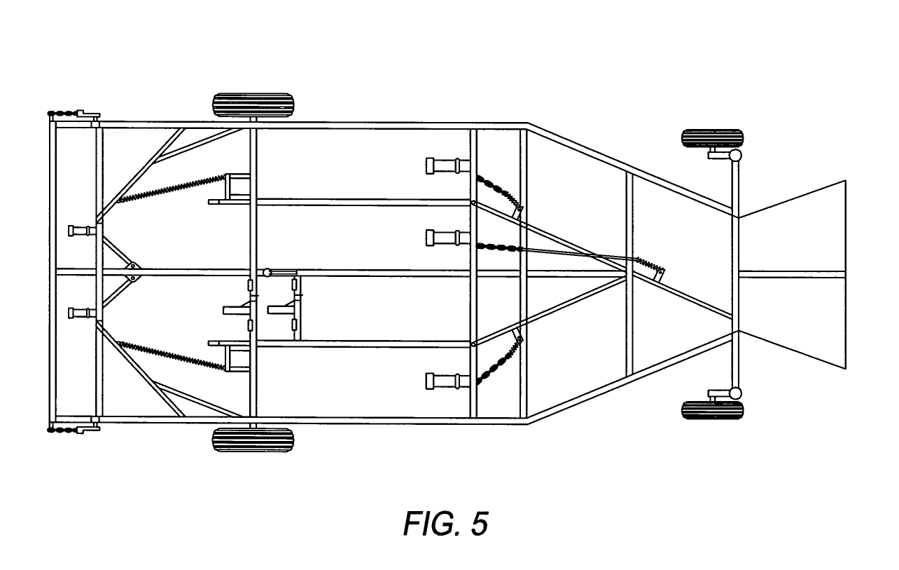

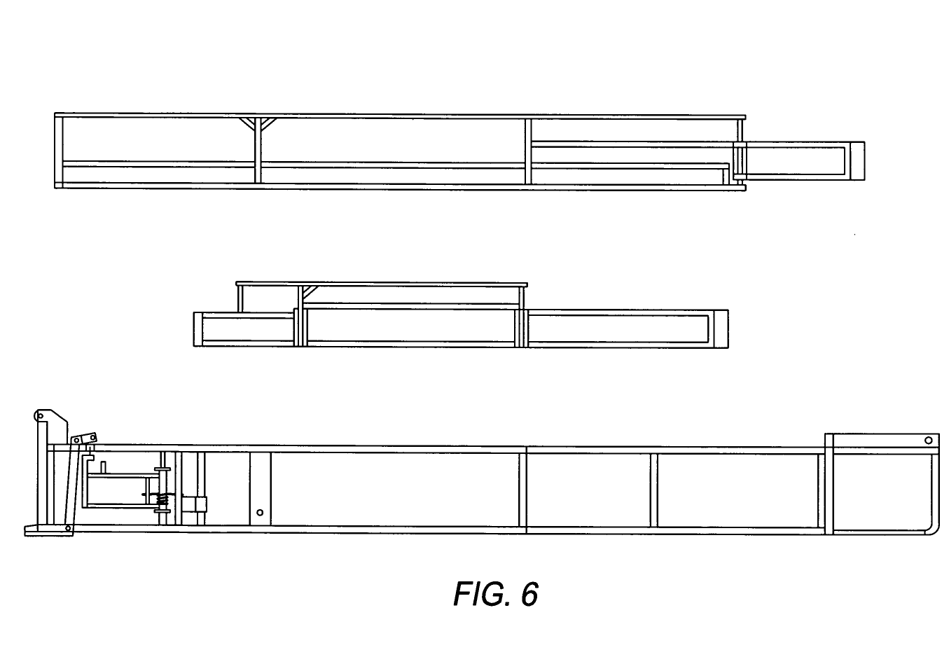

In a preferred embodiment of the present invention, the diverting mechanism is similar to a gate. The diverter is made of 1.5 inch strap steel in the shape of a rectangle. It is hinged at the back and has a spring attachment. It works by an attached ⅜ steel rod that is attached to the top of the diverter and to a pedal in the bale chute. It is activated by a bale passing under the pedal. Once a final bale of hay passes under the pedal, the last bale maintains the pedal in an up position, thereby shifting the diverter to allow hay bales to enter the other side of the accumulator. Once the compacted hay bale pack has exited the accumulator, the pedal returns to a down position allowing the diverter to return to its original position. FIG. 2 illustrates the use of a release element attached to at least one rear gate for releasing accumulated hay bales.

In a preferred embodiment of the present invention, a release mechanism is designed to work via a series of pedals. When the second to the last hay bale enters the accumulator it depresses a first pedal, causes the first pedal to rotate. The first pedal activates a ⅜ steel rod with a hook on the end to shift forward. When the hay bale depresses a second pedal, a perforated shackle is forced to drop down from a first high position to a second lower position. When the hay bales moves past the first pedal, the pedal returns to leaves its original position and the hook moves under the shackle. When a final hay bale enters the accumulator and depressed the first pedal, the hook engages the aperture of the perforated shackle thereby opening the rear gate at the back of the accumulator and is preferably hinged by a ⅜ rod. The rotation of this rod by the force of the hook and shackle initiates the movement of the gate latches and thus the release of the gate allowing the bale pack to exit the accumulator.

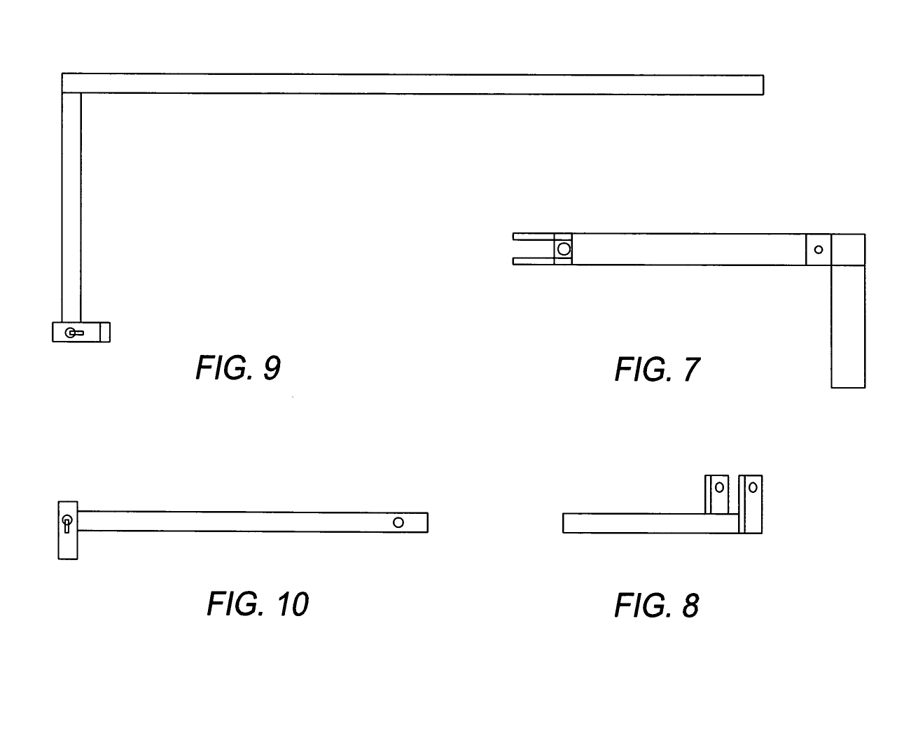

In another embodiment of a bale accumulation system, a second bale accumulator is attached in tandem to a first accumulator. Attachment means are illustrated in FIGS. 7-10. The tandem accumulator system is designed so that the frame of the second accumulator telescopes out from the first accumulator and allows for the accumulation of bales in both accumulators. When both accumulators are filled with hay bales, a final hay bales depresses or trips a release mechanism so that all accumulated hay bales are released. The advantage of such a tandem accumulator system is that two packs of compacted hay bale pads are released in close vicinity to each other, thereby reducing the distance traveled to acquire the hay bale pads and increasing the efficiency of the bale accumulation process.

The individual compacted hay bale packs can be lifted and moved with a grapple system. A grapple system is built by constructing a rectangular frame. Hooks are welded to pipe and placed in collars along the rectangular frame. A push bar is connected by straps of steel to each piece of pipe in the rectangular frame. The push bar is attached to the back of the grapple with a hydraulic cylinder. The grapple also has a rectangular box frame that attaches to a front end loader of a tractor. The steel framed box is attached to a rectangular frame containing the hooks.

The grapple system for use with the present invention is a series of hooks attached to pipe that are in turn attached to a push bar. The push bar is activated by a hydraulic cylinder. The hydraulic cylinder forces the push bar forward which in turn forces the pipe with the hooks attached to rotate. This rotation forces the hooks down into the bales of hay. Once the hooks are rotated into the bales of hay it allows the pack of compacted bales of hay to be picked up and transported.

Although preferred illustrative embodiments of the present invention are described above, it will be evident to one skilled in the art that various changes and modifications may be made without departing from the invention. The respective embodiments described above are concrete examples of the present invention; the present invention is not limited to these examples alone. The claims that follow are intended to cover all changes and modifications that fall within the true spirit and scope of the invention.

1. An apparatus comprising a carriage removably attached to a vehicle, wherein the carriage directs a bale of hay into a perpendicular position relative to at least one addition bale of hay.

2. The apparatus of claim 1 additionally comprising:
a) a wheeled housing with an entry and at least one diverter capable of directing a bale of hay into at least one shoot;
b) a turning gate for directing a bale of hay into a perpendicular position relative to additional bales of hay; and
c) and a release pedal attached to at least one rear gate for releasing accumulated hay bales.

3. The apparatus of claim 1 additionally comprising:
a) at least one shoot for accumulating at least one bale of hay;
b) at least one diverter for directing a bale of hay that has entered the at least one shoot; and
c) a release mechanism to trigger a rear gate to open and allow the exit of the at least one bale of hay.

4. The apparatus of claim 1 additionally comprising at least one turning means so as to position at least one hay ball perpendicular to at least one other hay bale.

5. The apparatus of claim 1 additionally comprising a wheeled housing with at least one turning means so as to move at least one hay bale in a biased position relative to at least one other hay bale.

6. An apparatus comprising:
a) a wheeled housing attached to a moving means
b) an entry, at least one diverter containing at least one shoot;
c) a turning gate to alter the direction of at least one bale of hay; and
d) a rear gate to release the at least one bale of hay.

6. The apparatus of claim 6, wherein the diverter directs at least one bale of hay into at least one shoot, wherein the bale of hay triggers the turning gate so the at least one bale of hay is position perpendicular to at least one additional bale of hay.

7. The apparatus of claim 6, additionally comprising a release peddle latchable attached to a rear gate.

8. The apparatus of claim 6, wherein a first bale of hay enters the wheeled housing, moves past the diverter into a shoot, contacts a cornering director and compresses a lever on the turning gate thereby moving the first bale of hay parallel to the rear gate and into a biased position relative to at least one additional bale of hay.

9. The apparatus of claim 8, wherein a final bale of hay enters the wheeled housing, moves past the diverter into a shoot and contacts the first bale of hay and is positioned perpendicular to the first bale of hay.

10. The apparatus of claim 8, wherein a final bale of hay enters the wheeled housing and depress a release lever attached via a latch to the rear gate, thereby releasing the at least first and final bales of hay from the wheeled housing.

11. A hay bale accumulator comprising an entry with at least one diverting mechanism leading to a coming director and a turning gate, wherein the turning gate further comprising;
i) a spring loaded lever; and
ii) a hooking mechanism

12. The hay bale accumulator of claim 11 additionally comprising two shoots divided by the diverting mechanism.

13. The hay bale accumulator of claim 11 additionally comprising a release lever latchable attached to a rear gate.

14. The hay bale accumulator of claim 12 wherein at least one hay bale enters the accumulator, is directed down a shoot by the diverting mechanism, contacts the turning gate, depresses the spring loaded lever thereby moving the turning gate from a first angled position into a second position flush against a wall of the accumulator, thereby positioning the hay bale perpendicular to the rear gate.

15. The hay bale accumulator of claim 12 wherein a final hay bale enter the accumulator and depresses the release peddle thereby disengaging the rear gate and releasing the hay bales from the accumulator.

16. A method for accumulating bales of hay in a housing attached to a vehicle comprising:
a) accumulating a first bale of hay into the housing that is directed into the housing and positioned parallel to a rear gate on the housing;
b) accumulating a final bale of hay into the housing that is directed into the housing and positioned perpendicular to the first bale of hay;
c) the final bale of hay depresses a release mechanism on the housing; and
d) the rear gate opens and releases the bales of hay.

17. The method of claim 16 wherein 10 bales of hay are accumulated.

18. The method of claim 16 wherein 8 bales of hay are accumulated.

19. The method of claim 16 wherein 12-16 bales of hay are accumulated.

20. The method of claim 16 wherein 5-7 bales of hay are accumulated.
